(19) United States
(12) Patent Application Publication
(10) Pub. No.: US 2024/0307150 A1
(43) Pub. Date: Sep. 19, 2024

(54) MODIFIED MOUTH PROP WITH SPACE TO ACCOMMODATE OPERATORS FINGER

(71) Applicants: Nezar Boreak, Jazan (SA); Shruti Nimbeni, Kamataka (IN); Basavaraj Nimbeni, Kamataka (IN); Suresh Shenvi, Kamataka (IN); Ruchi Gupta, Delhi (IN)

(72) Inventors: Nezar Boreak, Jazan (SA); Shruti Nimbeni, Karnataka (IN); Basavaraj Nimbeni, Karnataka (IN); Mohammad Samiullah, Karnataka (IN); Suresh Shenvi, Karnataka (IN); Ruchi Gupta, Delhi (IN)

(73) Assignee: Mohammad Samiullah, Karnataka (IN)

(21) Appl. No.: 17/945,140

(22) Filed: Sep. 15, 2022

(30) Foreign Application Priority Data
May 22, 2022 (IN) 202241030113

(51) Int. Cl. A61C 5/90

(52) U.S. Cl. CPC A61C 5/90

(57) ABSTRACT

This invention relates to devices aimed at effective separation and stabilization of upper and lower dental arches during dental treatment. A device configured to be used to stabilize mouth prop intra-orally by using operator's finger as the stabilizing aid. The proposed device is a polygonal bite block having flat wide proximal sides with upper and lower platforms to allow patient's upper and lower teeth to bite on the respective platforms.

### BACKGROUND

Field of Invention: This invention relates to devices aimed at effective separation and stabilization of upper and lower dental arches during dental treatment.

### DESCRIPTION OF RELATED ART

Dental treatment routinely requires separation of upper and lower dental arches or jaws for the operator to be able to effectively access the intra-oral area of the patient's mouth during dental examination and treatment procedures.

Most commonly used device to facilitate effective mouth opening, separation of jaws and their continuous stabilization in open jaw position are wedge-shaped devices known as mouth props or bite blocks.

Mouth props when used effectively, also protect the operator's finger in patient's mouth from accidental biting by the patient. Mouth props, however, are not always stable in patients' mouth especially in paediatric patients thereby resulting in unsuccessful treatment, or risk of injury to the patient or the operator.

### SUMMARY

Accordingly, an improved system to overcome the above problems is needed. To fulfil this need, a device configured to be stabilized by the operator during such procedures is provided in accordance with an embodiment. The proposed invention is a modified mouth prop with space to accommodate operator's finger.

In an embodiment, the proposed device is a polygonal bite block having flat wide proximal sides with upper and lower platforms to allow patient's upper and lower teeth to bite on the respective platforms.

In yet another embodiment, the proposed device has wedge-shaped outline where both platforms on upper and lower portions of the bite block are inclined towards central axis from anterior to posterior direction to match with opening angle of human jaws.

In yet another embodiment, the platforms on upper and lower portions of the bite block have horizontally placed deep uniform ridges to allow for positioning of the cusps on occlusal surfaces of human teeth in depressions between the horizontal ridges.

In yet another embodiment, the flat proximal sides of the bite block are slightly elevated above the level of horizontal ridges on platforms on upper and lower portions of the bite block to engage the buccal surfaces of the cusps on occlusal surfaces of human teeth to counter any horizontal forces from destabilizing the bite block from its intended position in between the teeth.

In yet another embodiment, the proposed device has an open-ended cylindrical hollow channel at the centre of the bite block running from anterior to posterior direction sufficiently wide to accommodate insertion of operator's finger.

In yet another embodiment, the open-ended cylindrical hollow channel is extended as a cylindrical tube in the anterior direction for better control and reach of operator's finger while the bite block is placed in its intended position between the patient's teeth, so that it is secured in place by the operator's finger.

The above objects and other objects, and features of the present invention are readily apparent from the following detailed description when read in connection with the accompanying drawings. Additionally, one ordinarily skilled in the art may understand and appreciate the advantages that are readily apparent from the following detailed description when read in connection with the accompanying drawings.

### BRIEF DESCRIPTION OF THE DRAWINGS

Embodiments are illustrated by way of example and not limitation in the figures of the accompanying drawings, in which like references indicate similar elements and in which:

FIG. 1 is an exemplary external view of the proposed device depicting major parts and internal structure.

FIG. 2 is an exemplary external view of the proposed device depicting positioning features on the upper and lower platforms.

FIG. 3 is an exemplary frontal view of the proposed device depicting stabilization features of proximal surfaces.

FIG. 4 is an exemplary schematic view of the proposed device depicting its intra-oral position and intended use.

### DETAILED DESCRIPTION OF THE INVENTION

The following detailed description includes references to the accompanying drawings, which form a part of the detailed description. The drawings show illustrations in accordance with example embodiments. These example embodiments are described in enough detail to enable those skilled in the art to practice the present subject matter.

However, it will be apparent to one of ordinary skill in the art that the present invention may be practiced without these specific details. In other instances, well-known methods, procedures, and components have not been described in detail so as not to unnecessarily obscure aspects of the embodiments. The embodiments can be combined, other embodiments can be utilized, structural or logical changes can be made without departing from the scope of what is claimed. The following detailed description is, therefore, not to be taken as a limiting sense.

Proposed here is a device configured to allow for insertion and placement of operator's finger within the wedge-shaped bite block while the block is being positioned and stabilized between the patient's upper and lower teeth.

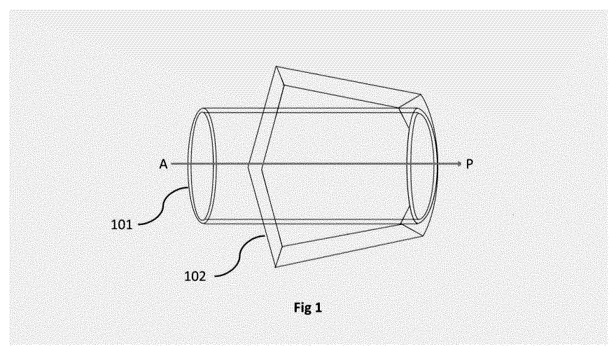

Referring to FIG. 1, illustrates external view of the proposed device depicting major parts of device comprised of open-ended hollow cylindrical channel 101, and polygonal wedge-shaped bite block 102.

FIG. 1 further depicts that a part of the open-ended hollow cylindrical channel 101 extends anteriorly without any enclosure wherein, A denotes anterior, and P denotes posterior portions of the proposed device.

FIG. 1 further illustrates that the polygonal wedge-shaped block 102 encloses the posterior two-thirds of the open-ended hollow cylindrical channel 101 without any interval to the hollow space existing within the open-ended cylindrical channel 101 either anteriorly or posteriorly.

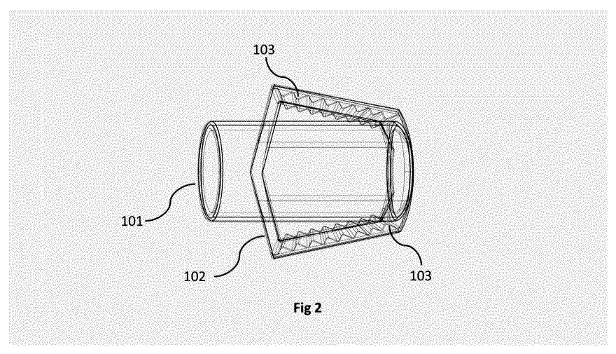

FIG. 2 is an exemplary external view of the proposed device depicting horizontally placed deep ridges 103 with uniformly distributed elevations and depressions on the inclined platforms on both upper and lower portions of the wedge-shaped bite block 102.

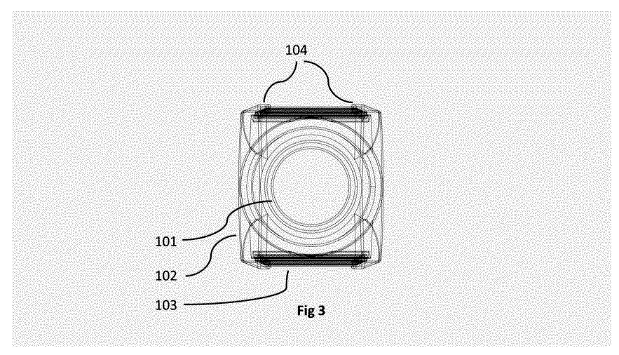

FIG. 3 is an exemplary frontal view of the proposed device depicting elevations 104 of the proximal surfaces at a height slightly above the level of horizontal ridges 103 present on both upper and lower platforms of the wedge-shaped bite block 102.

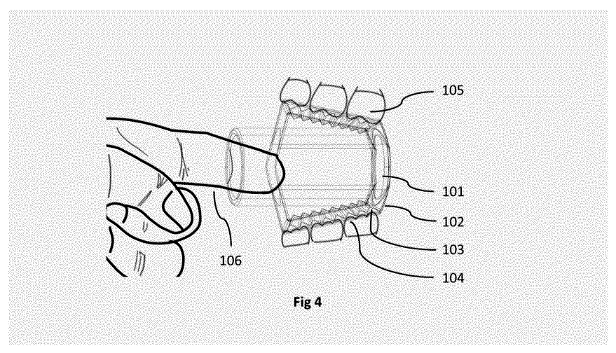

FIG. 4 is an exemplary schematic view of the proposed device depicting its intra-oral position and intended use. Cusps of teeth 105 of upper and lower dental arches are in position between the ridges 103 on the inclined platforms on upper and lower portions of the wedge-shaped bite block 102.

FIG. 4 further depicts that the buccal surfaces of teeth 105 of upper and lower dental arches are positioned between the elevations 104 of proximal surfaces at a height slightly above the level of horizontal ridges 103 present on both upper and lower platforms of the wedge-shaped bite block 102.

FIG. 4 further exemplifies the operator's finger 106 inserted and positioned inside the bite block 102 at the anteriorly extended portion of the open-ended hollow cylindrical tube 101 with an intention to stabilize the bite-block in the most favourable position while protecting the operator's finger from risk of accidental injury during the dental treatment procedure.

Additional advantages may be apparent to a person ordinarily skilled in the art in view of the details and the accompanying drawings.

Although, embodiments have been described with reference to specific example embodiments, it will be evident that various modifications, arrangements of components and changes may be made to these embodiments without departing from the broader spirit and scope of a device to facilitate function described herein. Accordingly, the specification and drawings are to be regarded in an illustrative rather than in a restrictive sense.

Many alterations and modifications of the present invention will no doubt become apparent to a person of ordinary skill in the art after having read the foregoing description. It is to be understood that the phraseology or terminology employed herein is for the purpose of description and not of limitation.

It is to be understood that the description above contains many specifications; these should not be construed as limiting the scope of the invention but as merely providing illustrations of some of the personally preferred embodiments of this invention. Thus, the scope of the invention should be determined by the appended claims and their legal equivalents rather than by the examples given.

We claim:

1. A device configured to be used to stabilize mouth prop intra-orally by using operator's finger as the stabilizing aid.

2. The device of claim 1, wherein the wedge-shaped mouth prop has an open-ended hollow cylindrical space at the centre.

3. The device of claim 1, wherein the hollow cylindrical space is extended anteriorly as a tube-like structure.

4. The device of claim 3, wherein the anterior tube-like structure is wide enough to accommodate operator's finger.

5. The device of claim 1, wherein horizontal ridges are present on both upper and lower inclined platforms of the wedge-shaped mouth prop.

6. The device of claim 1, wherein proximal surfaces of the mouth prop are extended slightly above the height of ridges on both upper and lower inclined platforms.

7. The device of claim 1, wherein the proposed device may be made using any suitable materials and manufacturing method to be able to function appropriately.
